(19) United States
(12) Patent Application Publication
(10) Pub. No.: US 2017/0042381 A1
(43) Pub. Date: Feb. 16, 2017

(54) Ice Cream Scoop

(71) Applicant: Michael Chou, South Lyon, MI (US)

(72) Inventor: Michael Chou, South Lyon, MI (US)

(21) Appl. No.: 14/821,951

(22) Filed: Aug. 10, 2015

(51) Int. Cl. A47J 43/20

(52) U.S. Cl. CPC A47J 43/20

(57) ABSTRACT

An ice cream scoop having an ergonomically angled handle allowing a more natural use of the hand and wrist while scooping ice cream. The handle also may come with raised portions or ridges to improve grip on the handle by the user. At the end opposite the gripping area, there is a scooping bucket designed to bite into hard frozen ice cream and contain substantially ball shaped portions of that ice cream. The ice cream scoop is made of a durable food safe substance such as stainless steel or aluminum.

### CROSS REFERENCE TO RELATED APPLICATIONS

This is a continuation-in-part application and the inventor hereby claims the benefit, pursuant to 35 U.S.C. 120, of the filing date of the earlier non-provisional application Ser. No. 29/474,350 by Michael Chou for an Ice Cream Scoop.

### STATEMENT REGARDING FEDERALLY SPONSORED RESEARCH AND DEVELOPMENT

This invention was not made using federally sponsored research and development. The inventors retain all rights.

### THE NAMES OF THE PARTIES TO A JOINT RESEARCH AGREEMENT

There is no joint research agreement.

### BACKGROUND OF THE INVENTION

This invention falls within the field of kitchen utensils, specifically ice cream scoops. Ice cream scoops are known to the art with straight cylindrical handles which require the user to turn the wrist in order to pry ice cream from the bucket into the scoop. This necessitates the use of small muscles and fragile joint structures to gouge loose the hard frozen ice cream.

### BRIEF SUMMARY OF THE INVENTION

In summary, this invention solves the problem of dislodging hard frozen ice cream with a scoop by equipping the scoop with an enlarged ergonomic process on the handle of the scoop against which the palm can push forward, engaging the ice cream with the front of the scoop. This use of the large muscles of the arm and shoulder together with the elimination of the prior twisting motion result in greater ease of dislodging ice cream into the scoop than is known to the prior art.

### BRIEF DESCRIPTION OF THE SEVERAL VIEWS OF THE DRAWINGS

FIG. 1 shows a front elevation view of the invention.

FIG. 2 shows a right side elevation view of the invention.

FIG. 3 shows a left side elevation view of the invention.

FIG. 4 shows a rear elevation view of the invention.

FIG. 5 shows a top plan view of the invention.

FIG. 6 shows a bottom plan view of the invention.

FIG. 7 shows a perspective view of the invention.

### DETAILED DESCRIPTION OF THE INVENTION

An ice cream scoop is described herein having an ergonomically angled handle allowing a more natural use of the hand and wrist while scooping ice cream. The handle also may come with raised portions or ridges to improve grip on the handle by the user. At the end opposite the gripping area, there is a scooping bucket designed to bite into hard frozen ice cream and contain substantially ball shaped portions of that ice cream. The ice cream scoop is made of a durable food safe substance such as stainless steel or aluminum.

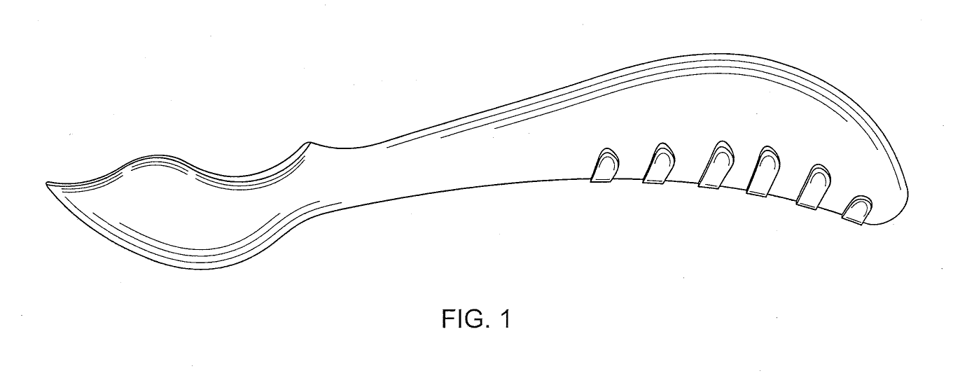

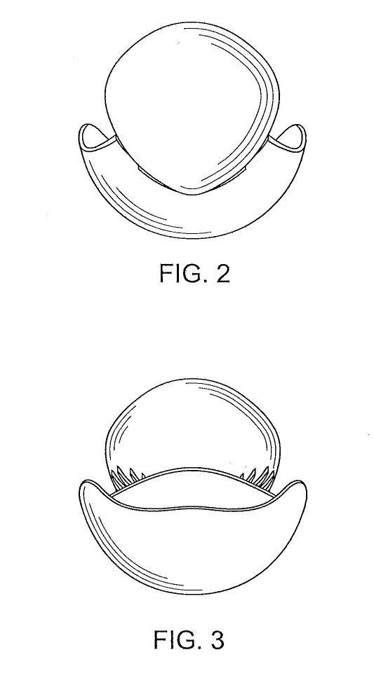

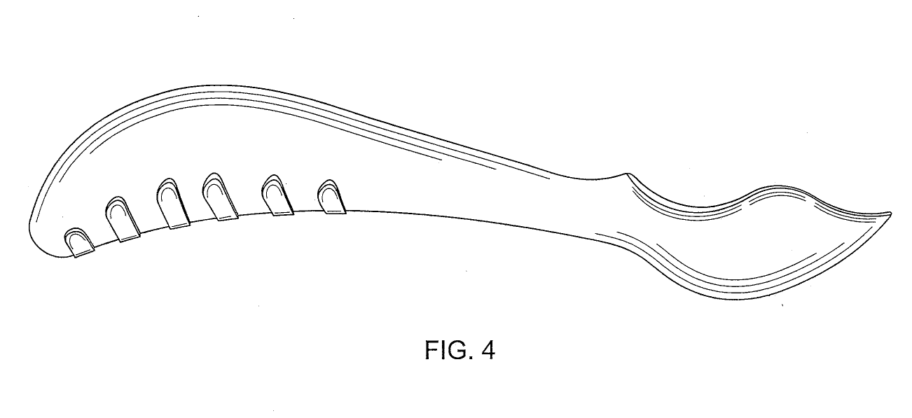

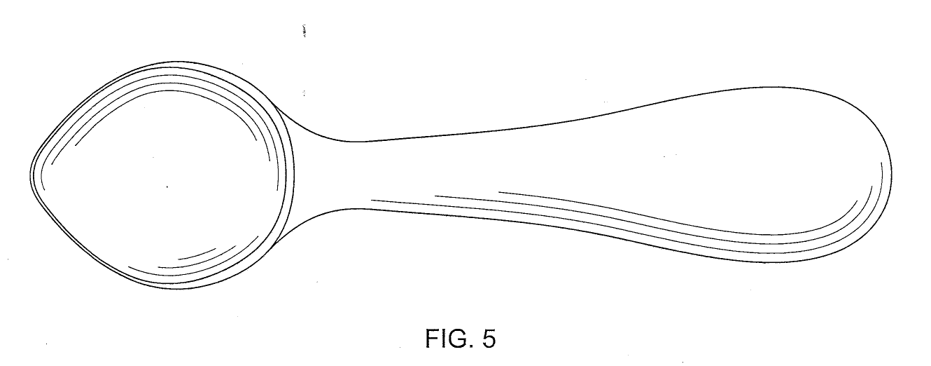

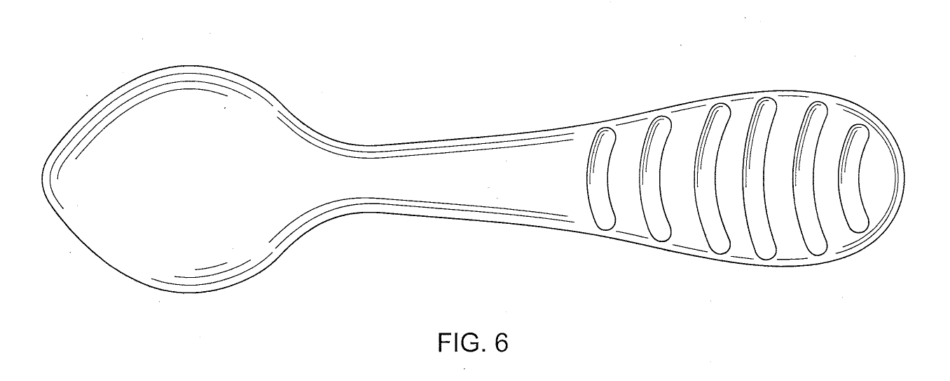

FIGS. 1-6 show a preferred embodiment of an ice cream scoop consistent with the instant invention.

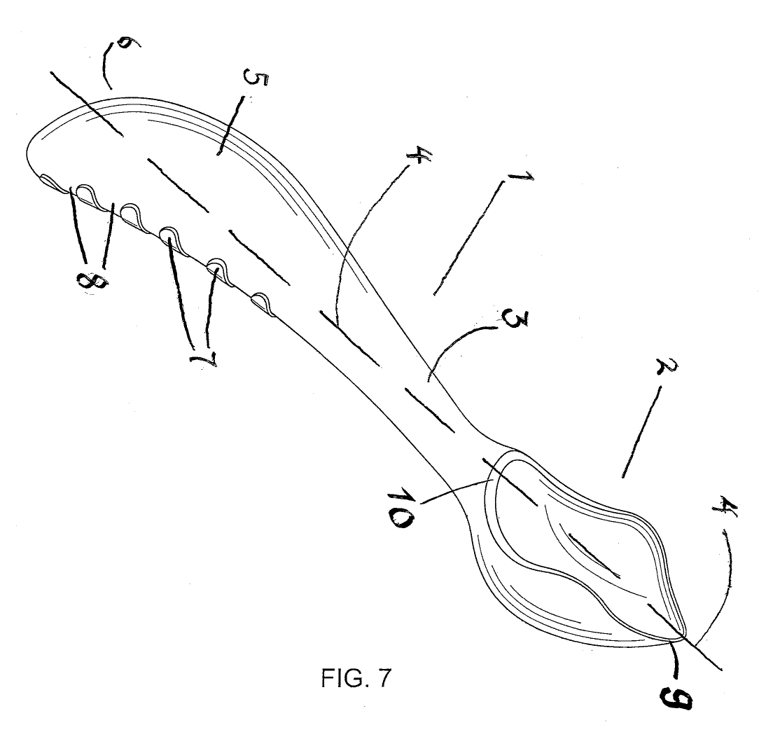

Referring now to FIG. 7, an ice cream scoop (1) is shown having a scooping bowl (2) and a handle (3) having an axis (4). An ordinary ice cream scoop has a straight handle and when the user attempts to scoop out hard ice cream using such a device, the arm and wrist must address the scoop and ice cream at an unnatural straight up and down angle, using a twisting motion around the axis, which requires the user to strain the arm forward thereby sacrificing torque. In the instant invention the handle (3) has a curved end (5) described above in the summary of the invention as an enlarged process (with the term process being used in the anatomical sense of a prominent or projecting portion of the invention). The heel of the hand can rest against the rear (6) of this curved end (5) while the fingers grip the handle in the region of protrusions (7) or valleys (8) which are found on the opposite side of the handle (3) with respect to the curved end (5). With this grip, the arm is angled back toward the user and the user can exert substantially more force into the ice cream surface from this more natural angle. The muscles of the upper arm or shoulder as well, as the pectoral muscles, can engage the ice cream scoop first in a direct thrusting motion along the direction of the axis (4) of the invention instead of twisting the scoop into the ice cream with the weaker forearm muscles.

The protrusions (7) may be in the form of transverse ridges, round bumps, chevrons or any other traction enhancing protrusions. The valleys (8) may be between or among protrusions (7) or may be traction assisting depressions similar to grooves or to the dimples of a golf ball without departing from the spirit of this invention. The bowl (2) has a front edge (9) and a back edge (10). The inventor expressly does not wish to be limited to the embodiment shown and intends to avail himself of the full scope of his rights under the doctrine of equivalents.

I claim:

1. A scoop for frozen food having a handle and a bowl; said handle being elongate and having an axis, a first end, and a second end; said bowl being located at said first end and having a rim and a cavity, said rim having a front and a back, said back being attached at said first end and said front being away from said first end so that said rim is substantially parallel with said axis, said rim being substantially circular, said substantially circular rim having a diameter that is parallel to said axis; said handle having a process at said second end, said process having a rear surface; whereby a user's palm can press against said rear of said process and drive said scoop in the direction of said axis engaging said frozen food with said front and collecting said frozen food into said cavity.

2. The scoop for frozen food of claim 1 further comprising hills on said handle located relatively near to said second end with respect to said axis.

3. The scoop for frozen food of claim 2 in which said hills are not on said process.

4. The scoop for frozen food of claim 1 further comprising valleys on said handle located relatively near to said second end with respect to said axis.

5. The scoop for frozen food of claim 4 in which said valleys are not on said process.

6. The scoop for frozen food of claim 1 having a lip on the front of the rim projecting away from the rim and away from the handle in the direction of the axis, the lip engaging the frozen food with a narrowed edge.

7. The scoop for frozen food of claim 6 in which said rim has a first wing and a second wing each extending above the average plane of said rim relative to said cavity, said first wing being located angularly around said rim substantially ninety degrees away from said lip and said second wing being located angularly around said rim substantially negative ninety degrees from said lip.
